(19) United States
(12) Patent Application Publication
(10) Pub. No.: US 2026/0154060 A1
(43) Pub. Date: Jun. 4, 2026

(54) PRODUCT UPDATE MANAGEMENT BASED ON POST-DISTRIBUTION FEEDBACK

(71) Applicant: Ivanti, Inc., South Jordan, UT (US)

(72) Inventors: Robin Rowe, Daresbury (GB); Christopher Goettl, Owatonna, MN (US)

(73) Assignee: Ivanti, Inc., South Jordan, UT (US)

(21) Appl. No.: 19/402,824

(22) Filed: Nov. 26, 2025

Related U.S. Application Data
(60) Provisional application No. 63/726,505, filed on Nov. 30, 2024.

(51) Int. Cl. G06F 8/65; G06Q 10/44

(52) U.S. Cl. CPC G06F 8/65; G06Q 10/44

(57) ABSTRACT

A method for automated product update analysis and management based on post-distribution feedback. The method includes distributing a product update to a first subset of endpoints and generating a data gathering mechanism to assess the functionality of the affected endpoints. After implementing the update, feedback data is collected from the endpoints and input into a product update validation model to identify any update rollout failures. If a failure is detected, the cause is mitigated before distributing the update to a second subset of endpoints. This approach ensures that product updates are thoroughly validated, and any issues are addressed before wider distribution.

### CROSS REFERENCE TO RELATED APPLICATIONS

This application claims priority to and the benefits of U.S. Provisional Application No. 63/726,505; filed Nov. 30, 2024, which is incorporated herein by reference in its entirety.

### FIELD

The embodiments described in this disclosure are related to automated product update analysis and management in managed networks. In particular, some embodiments related to automated product update management based on post-distribution feedback.

### BACKGROUND

In managed networks, update management services are implemented to ensure product updates and software patches are distributed to endpoints. The product updates may include new versions of the products or patches that address vulnerabilities or improve functionality of the products. The update management services can be automated using a distribution procedure. A common distribution procedure is a ring patch deployment procedure.

In a ring patch deployment procedure, a product update is rolled out or distributed to two or more subsets of endpoints sequentially. The subsets of endpoints are generally referred to as rings. For instance, a common ring patch deployment system includes a first ring that includes one percent (1%) of the endpoints, a second ring that includes another nine percent (9%), and a third ring that includes another ninety percent (90%) of the endpoints. The product update is distributed to the first ring, then the second ring in response to successful rollout in the first ring. The product update is rolled out to the third ring in response to successful rollout in the second ring.

Product updates might introduce productivity and functionality failures at endpoints. However, distribution of the product update in a subsequent ring in these and other conventional systems is based on successful installation of the product update on the endpoints in a previous ring. Successful installation or implementation of the product update does not indicate whether or to what extent the product update impacts productivity following the rollout. As a result, the product update may negatively impact the functionality of the endpoints, and the product update may be distributed to an entire network before the impact is identified.

Conventional product update distribution systems lack a mechanism that enables identification and quantification of the impact of product updates. Additionally, the product updates might change multiple aspects of the endpoint or systems operating on the endpoints. Accordingly, the effects of the product update are difficult to narrow down, which increases the difficulty in identifying and quantifying the failure. Accordingly, there is a need in the field of product update distribution to identify and quantify the impact of installation of product updates during and immediately following product update distribution.

The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of the invention, an embodiment includes a method of automated product update analysis and management based on post-distribution feedback. The method may include generating a social media-based symptom report. The generating the social media-based symptom report may include scraping posts related to the product update from two or more different internet websites. The scraping may be based on a data identifier associated with the product update. The data identifier may include a knowledge base (KB) number or a patch bulletin number associated with the product update. The generating a social media-based symptom report may include aggregating the posts from the internet websites and extracting content from the aggregated posts. Extracting the content may include filtering non-informational content. The generating a social media-based symptom report may include summarizing the posts based on a graph-based ranking operation into a collection of terms or phrases that are representative of a topic of the posts. The generating a social media-based symptom report may include analyzing the collection of terms or phrases to determine whether the topic is a problem with the product update. The social media-based symptom report identifies the problem with the product update. The method may include receiving a customer symptom report of an additional managed network. The customer symptom report may include an identification of a problematic aspect of a third subset of endpoints of the additional managed network that were affected by the product update. The method may include distributing a product update to a first subset of endpoints. The method may include generating a data gathering mechanism directed to functionality of an aspect of the first subset of endpoints affected by the product update. The method may include generating the data gathering mechanism based on the customer symptom report or based on the social media-based symptom report. After implementation of the product update at the first subset of endpoints, the method may include communicating the data gathering mechanism to the first subset of endpoints. The implementation may include a change or an update to a product installed at the first subset of endpoints. The method may include receiving feedback data from a portion of the subset of endpoints. The feedback data may be responsive to the data gathering mechanism and addresses the functionality of the aspect. The method may include inputting the feedback data into a product update validation model configured to identify an update rollout failure at the first subset of endpoints caused by the product update. The method may include receiving an output from the product update validation model. In response to the output including an indication of the update rollout failure at the first subset of endpoints, the method may include mitigating a cause of the update rollout failure prior to distributing the product update to a second subset of endpoints. The method may include distributing the product update to the second subset of endpoints.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example operating environment in which some embodiments described in the present disclosure may be implemented;

FIG. 2 depicts a block diagram of an example automated product update analysis process (“process”) based on post-distribution feedback that may be implemented in the operating environment of FIG. 1;

FIG. 3 illustrates an example computer system configured for automated product update analysis and management based on post-distribution feedback;

FIGS. 4A and 4B are a flowchart of an example method of automated product update analysis and management based on post-distribution feedback;

FIG. 5 is a flowchart of an example method of generating a social media-based symptom report;

FIG. 6 is a survey generation user interface (UX) that may be implemented in the process of FIG. 2;

FIGS. 7A and 7B are an endpoint communication UX that may be displayed on an endpoint during the process of FIG. 2.

FIG. 8 is a bot-management UX that may be implemented in a management device in the operating environment of FIG. 1; and

FIG. 9 is a post-patch survey UX that may be implemented in a management device in the operating environment of FIG. 1,

all according to at least one embodiment described in the present disclosure.

### DESCRIPTION OF SOME EXAMPLE EMBODIMENTS

The embodiments described in this disclosure are related to systems and methods of automated product update analysis and management based on post-distribution feedback. The embodiments of the present disclosure may be implemented to manage product update distribution or product update rollout in managed networks.

Some embodiments involve an automated approach to product update analysis and management based on feedback collected after distribution. The feedback collection is based on a data gathering mechanism such as a survey or questionnaire being generated. The data gathering mechanism is directed to a particular product update and directed to assessment of functionality of endpoints or aspects of the endpoints that may be affected by the particular product update. The particular product update is distributed or rolled out to a subset of endpoints in a managed network. After the product update is implemented at the subset of endpoints, the data gathering mechanism is communicated to the subset of endpoints. Based on the data gathering mechanism, feedback data is collected and input into a validation model to identify any rollout failures. If a failure is detected, the cause is mitigated before the product update is distributed to one or more additional subsets of endpoints. These and other embodiments may be implemented in a ring-based deployment operation. The feedback data is collected between distributions to different rings. The method ensures that any issues are addressed before wider distribution, enhancing the reliability of product updates.

Some embodiments leverage a validation model such an artificial intelligence (AI) engine to quickly analyze and process the feedback data and generate an output. The output is from the validation model might indicate a product rollout success (e.g., the product update does not materially deplete functionality at the subset of endpoints), a product rollout failure (e.g., the product update does materially deplete functionality of an aspect of the subset of endpoints), a mitigation action, or some combination thereof. With the output, distribution of the product update may be delayed to enable mitigation of a rollout failure, may proceed to distribution to an additional subset of endpoints, may adjust an aspect of the distribution process, or some combination thereof.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures is not intended to limit the scope of the systems and methods, as claimed, but is merely representative of example configurations of the systems and methods.

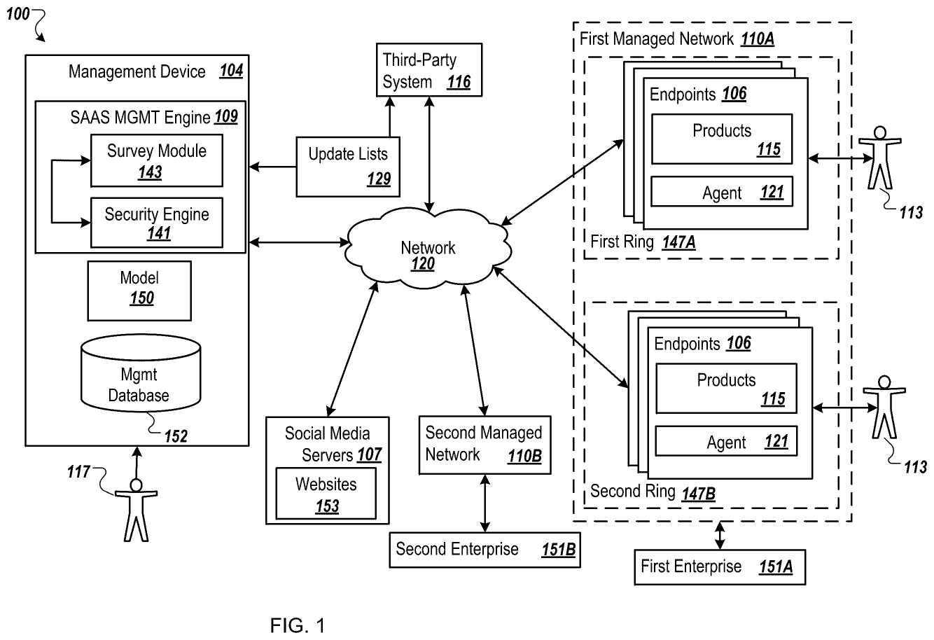

FIG. 1 is a block diagram of an example operating environment 100 in which some examples of the present disclosure can be implemented. The operating environment 100 may be configured for implementation of product update management in managed networks 110A and 110B (generally, managed network 110 or managed networks 110). The product update management may enable product updates such as patches and code changes to be accessed, consumed, and distributed to endpoints 106 of the managed networks 110. In the operating environment 100, a survey module 143 may be implemented along with a product update validation model 150 (hereinafter, “model 150”) to evaluate functionality of the endpoints 106 after distribution of the product updates, identify whether the product update has failed or is failing following rollout of the product updates, and provide endpoint configurations to mitigate or avoid a failed product update.

The survey module 143 and the model 150 gather and analyze data related to the functionality of the product update in a targeted and timely manner. For instance, the survey module 143 may autogenerate data gathering mechanisms such as surveys that are communicated in real time or immediately after the product update is distributed to a first subset of the endpoints 106. Feedback may then be fed back to the model 150, which analyzes the feedback to determine whether the product update introduces technical issues to the endpoints 106. For instance, in some embodiments, the survey module 143 and the model 150 may be implemented in systems implementing a ring-deployment operation to distribute product updates. In these and other embodiments, the endpoints 106A of a first managed network 110A may be separated into a first ring 147A and a second ring 147B. A first product update may be distributed to the first ring 147A. The survey module 143 may communicate a data gathering mechanism to the endpoints 106 of the first ring 147A either with the product updates or immediately after the first product update. The feedback may be gathered and processed by the model 150 prior to distribution of the first product update to the second ring 147B. Accordingly, an administrator 117 has information regarding whether the first product update introduces a technical issue into the first ring 147A and enables mitigation of the technical issue prior to distribution into the second ring 147B.

Moreover, the survey module 143 of FIG. 1 may be configured to intelligently generate the data gathering mechanism. For instance, the data gathering mechanism may be based on information and data gathered from social media servers 107 and a second managed network 110B. A security engine 141 may gather and process posts from the social media servers 107 to identify technical issues experienced by other computing devices after the first product update is implemented. The security engine 141 may then communicate the identified technical issues to the survey module 143. The data gathering mechanism may then focus or be directed to the identified technical issue and thus the feedback reflects whether the identified technical issue is experienced at the endpoints 106. Similarly, the second managed network 110B may communicate a report to the survey module 143 indicating whether a technical issue is experienced at other endpoints of the second managed network 110B after the first product update is implemented. Again, the data gathering mechanism may focus or be directed to the reported technical issue.

Accordingly, distribution of product updates in the operating environment 100 is improved from timely, technically relevant feedback regarding technical issues experienced by the endpoints 106 after implementation of product updates. The distribution may be adapted and the technical issues may be mitigated during or soon after the product update distribution. Operations of the survey module 143 and the security engine 141 result in early identification of the technical issues, which enable improved successful product update distribution.

The embodiments of the present disclosure address multiple technical problems of conventional systems. For example, in these conventional systems product updates are distributed to endpoints that may introduce technical issues. The technical issues in conventional systems are detected from tickets or error reports generated by the endpoints after the technical issue has propagated throughout the conventional system. There is no system in these conventional systems to identify and mitigate the technical issues early or during the product update distributions. The result is that the product updates are distributed to the entire system, the technical issues are widely experienced, and then must be corrected throughout the entire system. The embodiments described in the present disclosure gather relevant feedback during and immediately after distribution to identify and mitigate technical issues caused by the product update. Additionally, some embodiments are implemented in ring-deployment operations. In these embodiments, the technical issues may be identified during deployments in the early and smallest rings (e.g., 147A or 147B) and mitigated prior to distribution to later, larger rings. This prevents the technical issues resulting from the product update from being widely experienced in the first managed network 110A. Furthermore, some embodiments of the model 150 may implement an artificial intelligence (AI) engine or a machine learning (ML) engine. The AI engine or ML engine is trained to identify update rollout failure from the feedback. In these and other embodiments, the model 150 analyzes the feedback using the AI engine or ML engine to provide rapid output that can be used to assess whether a product update distribution is successful, and mitigation actions may be implemented to improve the implementation.

The embodiments of the present disclosure are directed to a computer-centric problem and are implemented in a computer-centric environment. For instance, the examples of the present disclosure are directed systems and methods configured to define and implement product update distribution procedures that access, analyze, and execute update package generation and distribution in the managed network 110. Computing processes occurring in the operating environment 100 include communication and implementation of product updates that include software patches and code changes on products 115 loaded on the endpoints 106. Communications during the processes described in this present disclosure involve the communication of data in electronic and optical forms via a network 120 and involve the electrical and optical interpretation of the data and information.

The operating environment 100 may include a management device 104, the managed networks 110, the social media servers 107, and a third-party system 116. The managed networks 110 include the endpoints 106. In the first managed network 110A, the endpoints 106 are separated into the ring 147A and 147B. The components of the operating environment 100 are configured to communicate data and information via a network 120 to perform product update distribution management as described in the present disclosure. Each of these components are described in the following paragraphs.

The network 120 may include any communication network configured for communication of signals between the components (e.g., 104, 116, 107, 110, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The third-party system 116 includes a hardware-based computer device or collection thereof that is configured to communicate with the other components of the operating environment 100 via the network 120. The third-party system 116 is configured to provide access to one or more update lists 129, portions thereof, and information pertaining to entries of the update lists 129. For instance, the third-party system 116 may host a website on which the update lists 129 are available. The third-party system 116 may host or store the update lists 129 such that information, metadata, and data related to entries on the update lists 129 may be accessed via the network 120. For instance, the management device 104 may be configured to access the update lists 129 or information related to entries on the update lists 129 via the network 120. In some examples, the management device 104 may be configured to communicate an electronic message to the third-party system 116 that accesses the update lists 129, information (e.g., update metadata) related to entries on the update lists 129, or a specific portion of the update lists 129. Some examples of example APIs for accessing the update lists 129 are available at https://www.circl.lu/services/cve-search/.

The update lists 129 may include a list of entries. The entries relate to a cybersecurity threat, a cybersecurity vulnerability, a software application code change, a patch, a hardware interface modification, or another update to a product (e.g., the products 115). The entries have information related to them. For instance, one or more of the entries may include an identification number, an entry date, an entry summary, a link to product updates (e.g., a code change or patch), a threat severity, vulnerability risk, vendor severity rating, other metadata, or some combination thereof.

An example of the third-party system 116 may be Department of Homeland Security (DHS) server(s). In this example, the update lists 129 may include lists of common vulnerabilities and exposures (CVEs) hosted by the DHS servers. Another example of the third-party system 116 may be National Institute of Standards and Technology (NIST) servers. In this example, the update lists 129 may include a national vulnerability database that is hosted by the NIST servers. The NIST server may host the information assurance vulnerability alerts (IAVAs), which may be an example of the update lists 129. One with skill in the art may be familiar with other suitable examples of the third-party system 116 and the update lists 129. Lists of vulnerabilities and threats are maintained by some additional entities such as MITRE.

In some embodiments, the update lists 129 may be consumed at the management device 104 to generate a content feed, which is sometimes referred to as an update or patch catalog. The content feed may be an aggregation of product updates included in the update lists 129. In addition to the aggregation of the updates, the content feed may include update files as well as detection and deployment logic used to patch the products 115. The content feed may be used in the security engine 141. For instance, the content feed may populate a user interface that provides visibility to outstanding updates for the products 115 as well as the characteristics and parameters of the outstanding updates. The content feed may also include an enumeration of outstanding product updates and update metadata associated with one or more of the outstanding product updates.

The content feed may include records and information related to previous product updates (e.g., a code change or patch) as well as outstanding product updates. As the update lists 129 become available, updated metadata or other information may be appended to the content feed. The content feed may be stored at least temporarily at the management device 104 or a management database 152. In other instances, the content feed may be stored remotely and accessed by the management device 104 via the network 120.

In some examples, the operating environment 100 may include a support device that consumes the update lists 129 and generates the content feed. In these examples, the management device 104 might receive the content feed from the support device.

The managed networks 110 include the endpoints 106 (in FIG. 1 only depicted with reference the first managed network 110A). To implement the managed networks 110, the endpoints 106 may be enrolled. After the endpoints 106 are enrolled, ongoing management of the endpoints 106 may be implemented by the management device 104. The ongoing management may include overseeing and dictating at least a part of the operations at the endpoints 106 as well as dictating or controlling product updates (e.g., a code change or a patch) implemented at the endpoints 106 as described in the present disclosure.

The managed networks 110 may be associated with an enterprise 151A or 151B, a portion of an enterprise, a government entity, or another entity or set of devices. For example, the first managed network 110A may be associated with a first enterprise 151A and the second managed network 110B may be associated with a second enterprise 151B. The managed networks 110 may be managed at least partially independently. For instance, a product update may be distributed in the second network 110B before the product update is distributed in the first network 110A. Additionally, parameters and timing of the distributions of the product update may differ between the first and the second networks 110A and 110B. Additionally still, the types of endpoints 106 and the products 115 may differ in the managed networks 110.

In some embodiments, a product update may be distributed to the second managed network 110B before it is distributed in the first managed network 110A or portion thereof. For instance, the product update may be completely rolled out in the second managed network 110B or may partially rolled out in the second managed network 110B before it is rolled out in the first managed network 110A. In these and other embodiments, the survey module 143 may collect information related to distribution of the product update in the second managed network 110B prior to distribution in the first managed network 110A. The information collected from the second managed network 110B may include a customer symptom report. The customer symptom report may include technical issues and problems experienced by endpoints (e.g., 106) in the second managed network 110B. Additionally or alternatively, the customer symptom report may include endpoint configurations, distribution process parameters, etc. related to the distribution in the second managed network 110B that caused or led to a successful product update rollout or a failed product update rollout.

The endpoints 106 may include hardware-based computer systems that are configured to communicate with the other components of the operating environment 100 via the network 120. The endpoints 106 may include any computer device that may be managed by the management device 104 and/or have been enrolled in the managed network 110. The endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines. The endpoints 106 may be referred to as managed endpoints when the endpoints 106 are included in the managed network 110.

The endpoints 106 may be associated with the users 113. The phrase “associated with” when describing the relationship between the endpoints 106 and the users 113 indicates that the users 113 generally or regularly operate the endpoints 106. The users 113 may be assigned a role or may be grouped with one or more other users 113.

The endpoints 106 include the products 115 and an agent 121. The agents 121 may be locally installed, at least temporarily, at the endpoints 106. For instance, the agents 121 may be installed at the endpoints 106 when the endpoints 106 are enrolled in the managed network 110 or when a particular service is loaded at the endpoints 106. The agents 121 may have access to information related to the products 115 and may be configured to communicate the information such as product metadata related to the products 115 to the management device 104. For instance, the agent 121 may have access to information related to the products 115. On its own or responsive to a request (from the management device 104 or another endpoint 106), the agent 121 may communicate the information related to the products 115 to the management device 104. The information related to the products 115 may include a current inventory of the products 115 as well as information or product metadata related to the products 115 such as version, vendor, type, hardware integrations, size, privacy policy, software interfaces, and the like. The agents 121 may also implement administrative and/or management processes within the managed network 110.

The products 115 may include applications of any kind or type. Some examples of the products 115 may include software applications, enterprise software, operating systems, and the like. The products 115 may differ between the endpoints 106. The products 115 may be individually patched or updated in some embodiments or circumstances. Additionally, two or more of the products 115 may have outstanding product updates at the same time (e.g., at the end of the month). Distribution of the two or more products 115 may be analyzed together. For instance, input data related to the two or more products 115 may be provided to the model 150. Accordingly, the survey module 143 may generate a distribution procedure and/or a parameter modification that are applicable to the two or more products 115.

In the first managed network 110A of FIG. 1, the endpoints 106 are separated into the first ring 147A and the second ring 147B (generally, ring 147 or rings 147). The first ring 147A includes a first subset of the endpoints 106 and the second ring 147B includes a second subset of the endpoints 106. The separation of the endpoints 106 into the rings 147 may be used during a ring-based deployment operation. In general, a product update may be distributed to one or the rings 147 followed by distribution to another of the rings 147. The number of the endpoints 106 in the rings 147 may differ. For instance, the first ring 147A may include one percent (1%) of the endpoints 106 in the first managed network 110A and the second ring 147B may include nine percent (9%) of the endpoints 106. The first managed network 110A may include more rings 147 (e.g., three, four, five rings) that include other suitable percentages of the endpoints 106, which may be based on device type, user role, function (e.g., production vs. test environments), and the like. In some embodiments, the rings 147 may be based on jurisdiction or geographic locations. For instance, the first ring 147A may be located in a first jurisdiction and the second ring 147B may be located in a second jurisdiction. Accordingly, the first ring 147A may be subject to different policies than the second ring 147B.

The social media servers 107 may include hardware-based computer systems that are configured to communicate with the other components of the operating environment 100 via the network 120. The social media servers 107 host the websites 153. The websites 153 are social media websites on which users can publish posts and interface (e.g., provide feedback) regarding the posts published by users. For example, a first user of one of the websites 153 may draft and publish a post. A second user of the website 153 may view the post in a feed of the first user or in a sub-forum of the website 153. The second user may interact in a variety of ways with the post. For instance, the second user may repost the original post to a feed of the second user, may vote for the post, may comment on the post, may like (or dislike, love, attach an emoji, etc.) the post, may share the post, or may otherwise interact with the post. Some or all of the data related to the interaction with the post may be recorded by the website 153. Additionally, the posts and the data related to the interaction with the post may be accessed or scraped by devices (e.g., the management device 104) via the network 120. Some examples of the social media server 107 may include a TWITTER® server, a REDDIT® server, a FACEBOOK® server, a GOOGLE® server, a WeChat® server, or a server operated by another entity on which users, who may be regarded as experts in the field, publish posts, articles, or other content regarding product update management, patch management, and other topics related to cybersecurity or product vulnerabilities.

The management device 104 is configured to manage product updates (e.g., a code change or a patch) at the endpoints 106. In general, management of the product updates may include determining which product updates pertain to the products 115, determining which of the product updates to distribute to the endpoints 106, and to distribute the product updates to the endpoints 106 such that the product updates may be locally implemented. Implementation of the product updates at the endpoints 106 include modification to computer code, programming code, or computer-executable instructions of a program that may include the products 115. In addition, in the operating environment 100, the management device 104 may be configured to leverage the model 150 to optimize one or more operations related to product update management as described elsewhere in the present disclosure.

The management device 104 may include a hardware-based computer system that is configured to communicate with the other components of the operating environment 100 via the network 120. In some examples, the management device 104 may be a single server, a set of servers, a virtual device, or a virtual server in a cloud-base network of servers. In these and other examples, the security engine 141, the survey module 143, and the model 150 may be spread over two or more cores, which may be virtualized across multiple physical machines.

The management device 104 may be associated with an administrator 117. The administrator 117 may be an individual, a set of individuals, or a system (e.g., a computing system) that interfaces with the management device 104. In some examples, the administrator 117 may provide input such as admin input to the management device 104. Input provided by the administrator 117 may form the basis of some computing processes performed by the management device 104. The user input may take the form of a selection of an icon or button on the management device 104 in some embodiments.

The management device 104 may provide one or more additional management operations to the endpoints 106 (e.g., in addition to product update managed). To provide the management operations, the management devices 104 includes a SAAS management engine (in the Figures “SAAS MGMT engine”) 109 that is configured to perform the one or more management operations relative to the endpoints 106. For instance, the SAAS management engine 109 may ensure the endpoints 106 are up to date, may ensure users 113 of the endpoints 106 have access to products 115 suitable for a role or function, the SAAS management engine 109 may provide technical support to the endpoints 106, and the like. In some embodiments, one or more modules of the SAAS management engine 109 may implement parameter modifications at the endpoints 106. For instance, the parameter modification may include disabling one of the products 115 at one of the endpoints 106. An application control module included in the SAAS management engine 109 may communicate a command that disables the product 115 at the endpoints 106.

The security engine 141 may be included in the SAAS management engines 109. The security engine 141 may be configured for automated software management of the endpoints 106 of the managed networks 110. In the operating environment 100, the security engine 141 may be configured to implement distribution procedures for product updates. The security engine 141 may then distribute one or more applicable product updates according to the distribution procedures.

The management device 104 may include the model 150 and a management database 152. The model 150 may include a security management AI engine. In these and other embodiments, the model 150 is trained on data representative of the operation of the endpoints 106 and is trained to identify an update rollout failure at a subset of the endpoints 106 caused by the product update. The model 150 may be further trained to process feedback from the endpoints to determine whether a product update rollout introduces a technical issue at the endpoints 106 or has been successfully rolled out. The model 150 may include a generative AI that is trained on at least some historical data representative of product updates, product update failure, feedback to surveys, product update metadata, characteristics of the endpoints 106, etc. The model 150 may include one or more ML algorithms implemented to understand the relationship between product update failures and underlying causes thereof. For instance, in some embodiments the model 150 may be configured to receive the feedback, analyze the feedback, and provide a percentage or a portion of the endpoints 106 that have implemented the product update and experienced a technical issue.

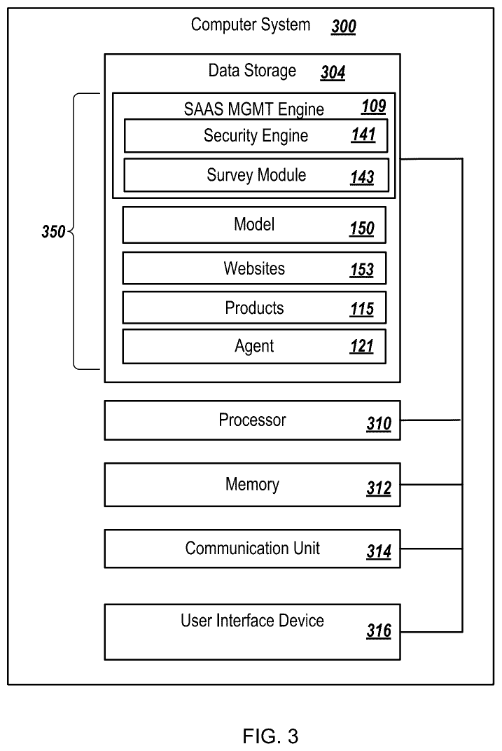

The management database 152 may include non-tangible, computer readable memory (e.g., the memory 312 of FIG. 3). The management database 152 may be configured to store historical product update data related to the managed network 110 and/or other networks. In addition, the management database 152 may store the content feed, lists of data related to the endpoints 106, the managed network 110, data related to outstanding product updates, and the like. The survey module 143 may access data and information stored at the management database 152.

The security engine 141, the survey module 143, and the model 150 may be configured to perform automated product update analysis and management based on post-distribution feedback. For instance, the survey module 143 may be configured to receive a customer symptom report from the second managed network 110B or another additional managed network. For instance, the security engine 141 may be preparing to distribute or distributing a product update to the first managed network 110A. The customer symptom report may be received from the second managed network 110B or another managed network that has implemented the product update. The customer symptom report may include an identification of a problematic aspect of a third subset of endpoints of the second managed network 110B that were affected by the product update.

The security engine 141 may generate a social media-based symptom report. The social media-based symptom report may be based on an analysis of scraped posts related to the product update from the websites 153. Some additional details of an embodiment of the analysis of the scrapped posts are provided in U.S. patent application Ser. No. 17/500,830, filed Oct. 13, 2021, which is incorporated herein by reference in its entirety. The social media-based symptom report identifies one or more problems with the product update. The security engine 141 may communicate the social media-based symptom report to the survey module 143.

The security engine 141 may distribute a product update to a first subset of the endpoints 106 such as the first ring 147A. After the product update is distributed to the first ring 147A, the survey module 143 may generate a data gathering mechanism. The data gathering mechanism is directed to functionality of an aspect of the endpoints 106 of the first ring 147A affected by the product update. The data gathering mechanism may be based on one or both of the customer symptom report and the social media-based symptom report. Some additional details of generation of the data gathering mechanism are provided in U.S. Provisional Patent Application No. 63/572,844, filed Apr. 1, 2024, which is incorporated herein by reference in its entirety.

After implementation of the product update at the first ring 147A or some portion thereof, the survey module 143 may communicate the data gathering mechanism to the first ring 147A.

In some embodiments, the survey module may be configured to generate a precursor or a supplement to the data gathering mechanism. The precursor may include a set of non-invasive steps or operations that are used to identify obvious side effects, faults, or issues. For instance, the precursor might include operations such as “reboot system,” “check secure boot status,” “check application issues,” etc. These operations may enable the user 113 to identify failures in the endpoints 106 or one of the products 115. The operations of the precursor can be implemented by the user 113 prior to submitting input to the data gathering mechanism.

The survey module 143 may receive feedback data from at least a portion of the endpoints 106 in the first ring 147A. The feedback data is responsive to the data gathering mechanism and addresses the functionality of the aspect after the product update is implemented.

The survey module 143 may input the feedback data to the model 150. The model 150 may determine whether implementation of the product update resulted in an update rollout failure. For instance, the model 150 might include the AI engine that generates an output related to analysis of the feedback data. The output may be communicated to the survey module 143.

In response to a determination or an indication of an update rollout failure at the first ring 147A, the security engine 141 or the SAAS management engines 109 may mitigate a cause of the update rollout failure. Mitigation of the cause of the update rollout failure may occur prior to the security engine 141 distributing the product update to the second ring 147B. In some embodiments, the mitigation of the cause includes modification of a parameter of one or more of the endpoints 106. Additionally or alternatively, the mitigation may include a modification to a distribution process according to which the product update is distributed.

In some embodiments, the output from the model 150 may include a mitigation action. The mitigation action may include a particular modification of the parameter of one or both of the first subset of endpoints 106 (in the first ring 147A) and the second subset of endpoints (in the second ring 147B). The mitigation action may be communicated to the SAAS management engine 109, which may implement the mitigation action.

After the mitigation occurs, the security engine 141 may then distribute the product update to another subset of the endpoints 106 such as the second ring 147B. Additionally, in response to a determination that distribution of the product update did not result in the update rollout failure (e.g., a determination that the distribution was successful), the security engine 141 may distribute the product update to the second ring 147B. For instance, the output from the model 150 may not include an indication of an update rollout failure at the first ring 147A. Accordingly, based on the output of the model 150, the security engine 141 distributes the product update to the second ring 147B with any mitigation step.

The agent 121, the model 150, the security engine 141, the survey module 143, the websites 153, the products 115, and components thereof may be implemented using hardware including a processor, a microprocessor (e.g., to perform or control performance of one or more operations), a field-programmable gate array (FPGA), or an application-specific integrated circuit (ASIC). In some other instances, the agent 121, the model 150, the security engine 141, the survey module 143, the websites 153, the products 115, and components thereof may be implemented using a combination of hardware and software. Implementation in software may include rapid activation and deactivation of one or more transistors or transistor elements such as may be included in hardware of a computing system (e.g., the endpoints 106 or the management device 104 of FIG. 1). Additionally, software defined instructions may operate on information within transistor elements. Implementation of software instructions may at least temporarily reconfigure electronic pathways and transform computing hardware.

Modifications, additions, or omissions may be made to the operating environment 100 without departing from the scope of the present disclosure. For example, the operating environment 100 may include three or more managed networks 110, one or more management devices 104, one or more endpoints 106, one or more social media servers 107, one or more third-party systems 116, or any combination thereof. Moreover, the separation of various components and devices in the examples described herein is not meant to indicate that the separation occurs in all examples. Moreover, it may be understood with the benefit of this disclosure that the described components and servers may generally be integrated together into a single component or server or separated into multiple components or servers.

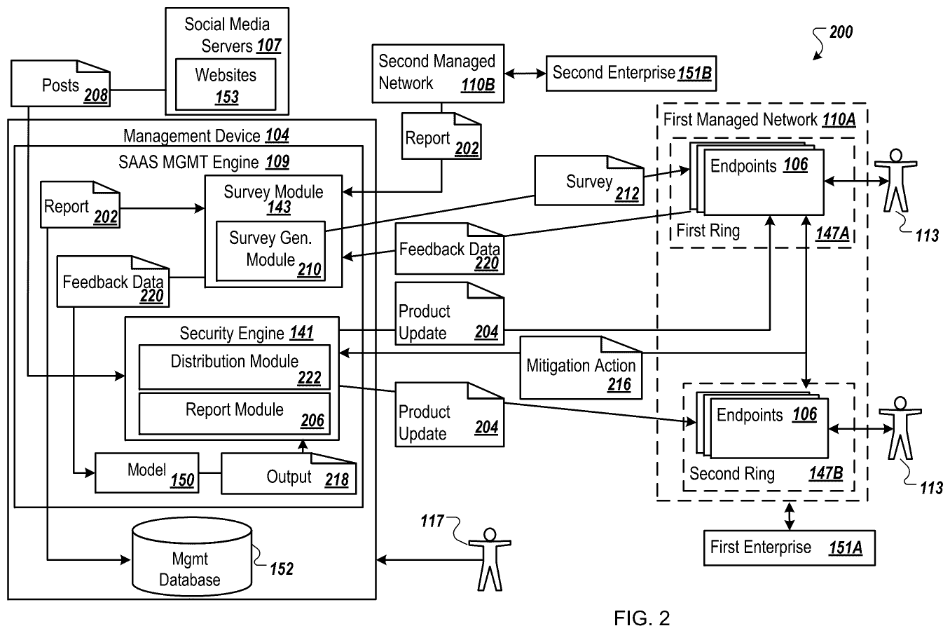

FIG. 2 depicts a block diagram of an example automated product update analysis process (hereinafter, “process”) 200 based on post-distribution feedback that may be implemented in the operating environment 100 of FIG. 1 or another suitable environment. The process 200 of FIG. 2 may include one or more components (104, 106, 107, 109, 121, 143, 147, 141, etc.) described with reference to FIG. 1. Although not depicted in FIG. 2, communication in the process 200 may be via a network such as the network 120 of FIG. 1.

The process 200 may begin by the survey module 143 receiving a customer symptom report 202 (hereinafter, “report 202”). The report 202 may be received from the second managed network 110B and may identify a problematic aspect of endpoints (e.g., 106) of the second network 110B that were affected by a product update 204. In some embodiments, the report 202 may be stored in the management database 152 and accessed by the survey module 143. For instance, the report 202 may be indexed according to the product update 204. Accordingly, in response to the product update 204 being outstanding in the first managed network 110A, the survey module 143 may access the report 202 related to the product update 204.

Additionally or alternatively, the security engine 141 may include a report module 206. The report module 206 may be configured to scrape posts 208 from the websites 153 of the social media servers 107. The security engine 141 may scrape the posts 208 based on a data identifier associated with the product update 204. Some examples of the data identifier include a knowledge base (KB) number or a patch bulletin number associated with the product update 204.

The report module 206 may aggregate the posts 208 from the websites 153 and extract content from the aggregated posts. The report module 206 may extract the content from the aggregated posts by filtering non-informational content from the aggregated posts. The report module 206 may summarize the posts 208 based on a graph-based ranking operation into a collection of terms or phrases that are representative of a topic of the posts 208. The report module 206 may analyze the collection of terms or phrases to determine whether the topic includes a problem with the product update 204.

The security engine 141 may generate a social media-based symptom report. The social media-based symptom report may be based on analysis of the scraped posts described above. For instance, the social media-based symptom report identifies the problem with the product update 204 that appears in the collection of terms and phrases.

In the depicted embodiments, the social media-based symptom report and the report 202 may be used by the management device 104. In some embodiments, the management device 104 may not use both the report 202 and the social media-based symptom report. For instance, the product update 204 may not have been distributed in the second managed network 110B, but may have a large number of posts 208 on the websites 153. In these and other embodiments, the report 202 may not be received. Additionally or alternatively, in some circumstances, the second managed network 110B may have distributed the product update 204, but there may be few or no posts 208 related to the product update 204. In these embodiments, the report 202 may be received, but the social media-based symptom report may not be generated. Moreover, in some circumstances, neither the social media-based symptom report nor the report 202 may be used by the management device 104.

The survey module 143 may include a survey generation module 210. The survey generation module 210 may receive one or both of the report 202 and social media-based symptom report. The survey generation module 210 may generate a data gathering mechanism 212 (in FIG. 2, “survey”). The gathering mechanism 212 is directed to functionality of an aspect of the endpoints 106 affected by the product update 204. The data gathering mechanism 212 may be generated based on one or both of the report 202 and the social media-based symptom report.

For example, the report 202 may indicate that one of the products (e.g., 115) may not function after installation of the product update 204. Accordingly, the data gathering mechanism 212 may include a question directed to the product update. Similarly, the social media-based symptom report may indicate that endpoints are experiencing a particular technical issue during a particular process. Accordingly, the data gathering mechanism 212 may request the user 113 perform the process to determine whether the particular technical issue is experienced. Additionally or alternatively, the gathering mechanism may request a “thumbs up” or “thumbs down” from one of the users 113.

In addition, in some embodiments, the survey module 143 may be configured to generate a precursor. The precursor includes a set of operations and instructions that might be implemented by the user 113 to help evaluate the endpoint 106 following the distribution of the product update 204. The precursor might include, for example, a notification that the product update 204 is scheduled and one or more operations such as “check for application issues” with associated instructions such as “Try opening a few of your commonly used applications (such as your internet browser, email client, or office applications) to ensure they run as expected.” The precursor might be communicated concurrently with the data gathering mechanism 212 or may be communicated prior to the communication of the data gathering mechanism 212.

The security engine 141 may include a distribution module 222. The distribution module 222 may be configured to distribute the product update 204 to the first ring 147A or a first subset of the endpoints 106 in the first managed network 110A. In some embodiments, the data gathering mechanism 212 may be generated prior to the distribution of the product update 204 to the first ring 147A. In other embodiments, the distribution to the first ring 147A and the data gathering mechanism 212 generation may occur concurrently or at least partially concurrently.

The survey module 143 may communicate the data gathering mechanism 212 to the endpoints 106 of the first ring 147A. In some embodiments, the data gathering mechanism 212 may be communicated with the product update 204. In other embodiments the data gathering mechanism 212 may be communicated after the product update 204 is implemented. For instance, the endpoints 106 of the first ring 147A may implement the product update 204. The implementation includes a change or an update to one or more products installed at the endpoints 106 that received the product update 204. After implementation of the product update 204 at the first ring 147A, the first subset of endpoints 106, or some portion thereof, the survey module 143 may communicate the data gathering mechanism 212.

The survey module 143 may receive feedback data 220. The feedback data 220 may be received from at least a portion of the endpoints 106 of the first ring 147A. The feedback data 220 is responsive to the data gathering mechanism 212. For instance, the feedback data 220 addresses the functionality of the aspect that is the topic of the data gathering mechanism 212.

The survey module 143 may input the feedback data 220 to the model 150. The model 150 is configured to analyze the feedback data 220 to identify an update rollout failure at the first ring 147A caused by the product update 204. In some embodiments, the model 150 is configured to determine whether a threshold number of the endpoints 106 on which the product update 204 is implemented experienced a fault or failure (e.g., a non-functional product 115, an inaccessible product 115, an inoperable operating system, error or fault notifications, etc.).

In some embodiments, the model 150 is configured to generate an output 218. The output 218 may be communicated to the security engine 141. The output 218 may include an indication of the update rollout failure at the endpoints 106 of the first ring 147A or an indication of a successful update rollout. For example, the output 218 may indicate whether a threshold number of the endpoints 106 are functional following distribution of the product update 204. For instance, the first ring 147A may include one hundred endpoints 106. The feedback data 220 may be received from eighty-five of the endpoints 106 and seventy-five indicate that the product update 204 causes a particular technical issue. From the feedback data 220, the model 150 may generate the output 218 to indicate that three-quarters of the endpoints 106 in the first ring 147A are experiencing the technical issue and categorize the distribution to the first ring 147A as an update rollout failure. Alternatively, the feedback data 220 may indicate that of the eighty-five endpoints 106 that responded, forty-five of the endpoints 106 experience a technical issue and thirty of the endpoints 106 do not experience the technical issue. In response, the model 150 may analyze features of the third endpoints 106 such as device type, product version, jurisdiction, network connection type, product inventory, operating system, etc. The output 218 may include some additional information related to feature-based analysis, such as “endpoints 106 of a particular device type experience failures while other device types do not.”

The output 218 may further include a mitigation action 216. The mitigation action 216 may include a command or an instruction that modifies a parameter of one or more of the endpoints 106 or a parameter of a deployment process. For instance, the output 218 may indicate that the update rollout failure occurs in the endpoints 106 with an Apple™ operating system. The output 218 may include an instruction to remove endpoints 106 from the second ring 147B with the Apple operating system or may provide instructions to utilize another mechanism for distribution (e.g., Apple MDM management tools) of the product update 204 to the endpoints 106 having the Apple operating system. Additionally or alternatively, the model 150 may determine that a device configuration such as firewall setting is preventing or interfering with the product update 204. Accordingly, the output 218 may include an instruction to modify the firewall setting in the endpoints 106 prior to distribution.

The security engine 141 may receive the output 218 from the model 150. In response to the output 218 including an indication of the update rollout failure at the first ring 147A, the security engine 141 or another of the SAAS management engines 109 may mitigate a cause of the update rollout failure. The mitigation may be implemented prior to distribution of the product update 204 to the second ring 147B. In embodiments in which the output 218 includes the mitigation action 216, mitigation of the cause of the update rollout failure may include modification of the parameter of the endpoints or a distribution process according to the mitigation action 216. In response to the output 218 not including an indication of a failure of the rollout of the product update 204 to the first ring 147A, the distribution module 222 may distribute the product update 204 to the second ring 147B or another second subset of the endpoints 106.

The embodiment of FIG. 2 depicts an example of the process 200 in which a distribution procedure includes a ring-based deployment operation. In these and other embodiments, the communication of the data gathering mechanism 212 occurs between distribution to the first ring 147A and the second ring 147B. Additionally, the mitigation the cause of the update rollout failure occurs after the distribution to the first ring 147A and prior to a distribution to the second ring 147B.

In other embodiments, the distribution procedure may not include the rings 147. In these and other embodiments, the product update 204 may be distributed to a first subset of the endpoints 106. The feedback data 220 may be received from the first subset of the endpoints 106. The feedback data 220 may be input to the model 150 to enable evaluation of the functionality of the product update 204 in the first subset of the endpoints 106. The product update 204 may then be distributed to a second, third, fourth, etc. subset of the endpoints 106. During each subsequent distribution the feedback data 220 may be received and analyzed.

In yet other embodiments, the endpoints 106 of the first managed network 110A may receive the product update 204 together. In these and other embodiments, the data gathering mechanism 212 may be generated to specifically identify potential issues that might exist following distribution. The data gathering mechanism 212 may be used to generate reports 202 that may be communicated to other managed networks 110.

FIG. 3 illustrates an example computer system 300 configured for automated product update analysis and management based on post-distribution feedback, according to at least one embodiment of the present disclosure. The computer system 300 may be implemented in the operating environment 100 FIG. 1, for instance. Examples of the computer system 300 may include the management device 104, the third-party system 116, one or more of the endpoints 106, the social media servers 107, or some combination thereof. The computer system 300 may include one or more processors 310, a memory 312, a communication unit 314, a user interface device 316, and a data storage 304 that includes one or more or a combination of the SAAS management engine 109, the security engine 141, the survey module 143, the model 150, the products 115, the websites, and the agent 121 (collectively, system modules 350).

The processor 310 may include any suitable special-purpose or general-purpose computer, computing entity, or processing device including various computer hardware or software modules and may be configured to execute instructions stored on any applicable computer-readable storage media. For example, the processor 310 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 3, the processor 310 may more generally include any number of processors configured to perform individually or collectively any number of operations described in the present disclosure. Additionally, one or more of the processors 310 may be present on one or more different electronic devices or computing systems. In some embodiments, the processor 310 may interpret and/or execute program instructions and/or process data stored in the memory 312, the data storage 304, or the memory 312 and the data storage 304. In some embodiments, the processor 310 may fetch program instructions from the data storage 304 and load the program instructions in the memory 312. After the program instructions are loaded into the memory 312, the processor 310 may execute the program instructions.

The memory 312 and the data storage 304 may include computer-readable storage media for carrying or having computer-executable instructions or data structures stored thereon. Such computer-readable storage media may include any available media that may be accessed by a general-purpose or special-purpose computer, such as the processor 310. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 310 to perform a certain operation or group of operations.

The communication unit 314 may include one or more pieces of hardware configured to receive and send communications. In some embodiments, the communication unit 314 may include one or more of an antenna, a wired port, and modulation/demodulation hardware, among other communication hardware devices. In particular, the communication unit 314 may be configured to receive a communication from outside the computer system 300 and to present the communication to the processor 310 or to send a communication from the processor 310 to another device or network (e.g., the network 120 of FIG. 1).

The user interface device 316 may include one or more pieces of hardware configured to receive input from and/or provide output to a user. In some embodiments, the user interface device 316 may include one or more of a speaker, a microphone, a display, a keyboard, a touch screen, or a holographic projection, among other hardware devices.

The system modules 350 may include program instructions stored in the data storage 304. The processor 310 may be configured to load the system modules 350 into the memory 312 and execute the system modules 350. Alternatively, the processor 310 may execute the system modules 350 line-by-line from the data storage 304 without loading them into the memory 312. When executing the system modules 350, the processor 310 may be configured to perform one or more processes or operations described elsewhere in this disclosure.

Modifications, additions, or omissions may be made to the computer system 300 without departing from the scope of the present disclosure. For example, in some embodiments, the computer system 300 may not include the user interface device 316. In some embodiments, the different components of the computer system 300 may be physically separate and may be communicatively coupled via any suitable mechanism. For example, the data storage 304 may be part of a storage device that is separate from a device, which includes the processor 310, the memory 312, and the communication unit 314, that is communicatively coupled to the storage device. The embodiments described herein may include the use of a special-purpose or general-purpose computer including various computer hardware or software modules, as discussed in greater detail below.

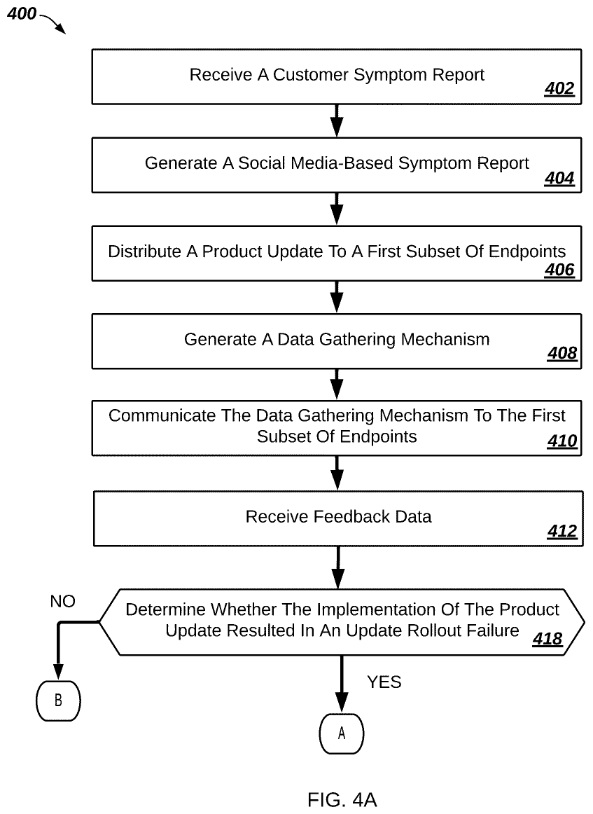

FIGS. 4A and 4B are a flowchart of an example method 400 of automated product update analysis and management based on post-distribution feedback, according to at least one embodiment of the disclosure. Referring to FIG. 4A, the method 400 may begin at block 402 in which a customer symptom report may be received. The customer symptom report may be received from an additional managed network. The customer symptom report may include an identification of a problematic aspect of a third subset of endpoints of the additional managed network that were affected by the product update.

At block 404, a social media-based symptom report may be generated. The social media-based symptom report may be based on scraped posts related to the product update from two or more different internet websites. The social media-based symptom report may identify a problem with the product update or rollout thereof. At block 406, a product update may be distributed to a first subset of endpoints.

At block 408, a data gathering mechanism may be generated. The data gathering mechanism may be directed to functionality of an aspect of the first subset of endpoints affected by the product update. In some embodiments, the data gathering mechanism may be generated based on one or both of the customer symptom report and the social media-based symptom report.

At block 410, the data gathering mechanism may be communicated to the first subset of endpoints. The data gathering mechanism may be communicated to the first subset after implementation of the product update at the first subset of endpoints. The implementation may include a change or an update to a product installed at the first subset of endpoints or a change in a setting or configuration of the product, an associated product, a hardware component, or some combination thereof.

At block 412, feedback data may be received. The feedback data may be received from a portion or all of the subset of endpoints. The feedback data is responsive to the data gathering mechanism and may address the functionality of the aspect.

At block 418, it may be determined whether the implementation of the product update resulted in an update rollout failure. In some embodiments, the feedback data may be input to a product update validation model. The update validation module may be configured to identify an update rollout failure at the first subset of endpoints caused by the product update. The update validation module may generate an output that includes an indication of the update rollout failure. For instance, the output may include an indication that a threshold number (e.g., 75%, 80%, or another suitable threshold) of the first subset of endpoints are functional following distribution of the product update. In response to the threshold number being met, the product update rollout may be identified as successful. In response to the threshold number not being met, the product update rollout may be identified as a failure.

In response to the determination of the update rollout failure at the first subset of endpoints (“Yes” at block 420), the method 400 may proceed to block 420. In response to a determination that there was not an update rollout failure at the first subset of endpoints (“No” at block 420), the method 400 may proceed to block 422. Referring to FIG. 4B, at block 420, a cause of the update rollout failure may be mitigated. The cause of the update rollout failure may be mitigated prior to distributing the product update to a second subset of endpoints. In some embodiments, the output may further include a mitigation action. The mitigation action may include a link or command that modifies a parameter of one or both of the first subset of endpoints and the second subset of endpoints. The mitigating the cause may include communicating the link or the command to one or both of the first subset of endpoints and the second subset of endpoints to modify the parameter according to the mitigation action. In some embodiments, the mitigating the cause of the update rollout failure may include analyzing extracted content from the scraped posts. The extracted content may be analyzed to identify a solution to a problem that is the cause of the update rollout failure. At block 422, the product update may be distributed to the second subset of endpoints.

In some embodiments, the distribution procedure may include a ring-based deployment operation. In these and other embodiments, the communication of block 410 may occur between rings of the ring-based deployment operations. For instance, the operations of block 410 may occur between distribution to a first ring of the ring-based deployment operation that includes the first subset of endpoints and a second ring of the ring-based deployment operation that includes the second subset of endpoints. Additionally, in these and other embodiments, the mitigating of block 420 may occur between rings of the ring-based deployment operations. For instance, the operations of block 420 may occur after the distribution to the first ring and prior to a distribution to the second ring.

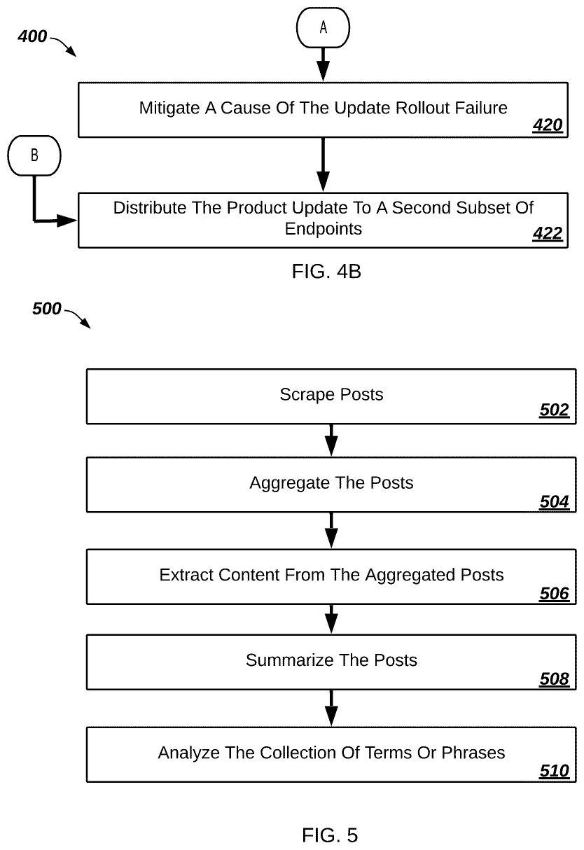

FIG. 5 is a flowchart of an example method 500 of generating a social media-based symptom report. The method 500 may be implemented in another method such as in block 404 of the method 400 of FIG. 4A. The method 500 may begin at block 502 in which posts may be scraped. The scraped posts may be related to the product update and may be scraped from two or more different internet websites. In some embodiments, the scraping is based on a data identifier associated with the product update. The data identifier may include a knowledge base (KB) number or a patch bulletin number associated with the product update.

At block 504, the posts may be aggregated. At block 506, the content may be extracted from the aggregated posts. In some embodiments, the extracting the content includes filtering non-informational content. At block 508, the posts may be summarized. For instance, the posts may be summarized based on a graph-based ranking operation into a collection of terms or phrases that are representative of a topic of the posts and the extracted content.

At block 510, the collection of terms or phrases may be analyzed. The collection of terms or phrases may be analyzed to determine whether the topic is a problem with the product update. The social media-based symptom report may include the topic. For instance, in response to the topic being the problem with the product update, the social media-based symptom report may include the topic, the problem, comments and solutions related to the problem, other information related to the topic, or some combination thereof.

The methods 400 and 500 may be performed by the management device 104 described elsewhere in the present disclosure or by another suitable computing system, such as the computer system 300 of FIG. 3. In some embodiments, the management device 104 or the other computing system may include or may be communicatively coupled to a non-transitory computer-readable medium (e.g., the memory 312 of FIG. 3) having stored thereon programming code or instructions that are executable by one or more processors (such as the processor 310 of FIG. 3) to cause a computing system or the management device 104 to perform or control performance of the methods 400 and 500. Additionally or alternatively, the management device 104 may include the processor 310 that is configured to execute computer instructions to cause the management device 104 or other computing systems to perform or control performance of the methods 400 and 500. The management device 104 or the computer system 300 implementing the methods 400 and 500 may be included in a cloud-based managed network, an on-premises system, or another suitable network computing environment. Although illustrated as discrete blocks, one or more blocks in FIGS. 4A-5 may be divided into additional blocks, combined into fewer blocks, or eliminated, depending on the desired implementation.

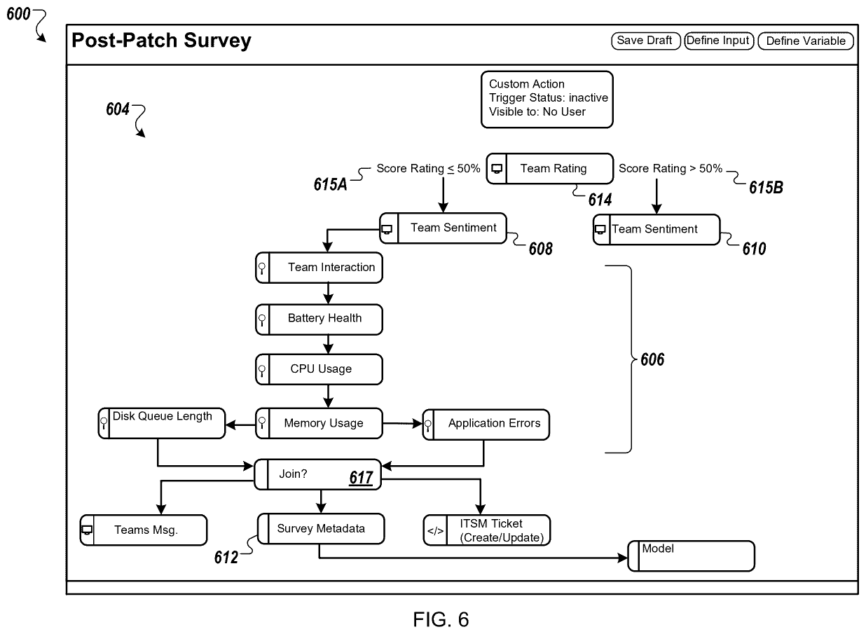

FIG. 6 is a survey generation user interface (UX) 600 that may be implemented in the process 200 or another suitable process. The survey generation UX 600 may be used by an administrator (e.g., 117 of FIG. 1) to generate a post-patch survey, which is an example of the data gathering mechanism 212. The survey generation UX 600 includes a low-code interface that enables programmatic generation though use of one or more graphics that represent code fragments and functions.

In the survey generation UX 600, a post-patch survey low code workflow (workflow) 604 is depicted. The workflow 604 includes a rating action 614, which may request a rating of a user (e.g., 113 of FIG. 1) following distribution of a product update to an endpoint associated with the user. Conditions 615A and 615B dictate progression through the workflow 604. A first condition “score rating ≤50% may indicate a technical issue at the endpoint. A second condition “score rating >50%” may indicate the endpoint is functional following implementation of the product update. The sentiment operations 608 and 610 may include a statement addressing a response submitted in response to the rating action 614. Action operators 606 may present or implement inquiries regarding functional aspects of the endpoint and a product. In the example of FIG. 6, “battery health, CPU usage, memory usage, application errors, etc.” are checked via a question or via a request of corresponding to an aspect of the endpoint. A join action 617 may provide the user with an option or interact with the user to resolve a technical issue. Based on a selection of the join action, the workflow 604 may proceed to an action to generate an information technology service management (ITSM) ticket or interact with an IT representative or bot. Additionally, following the join action 617, metadata regarding the survey may be communicated using a communication action 612 to a model such as the model 150.

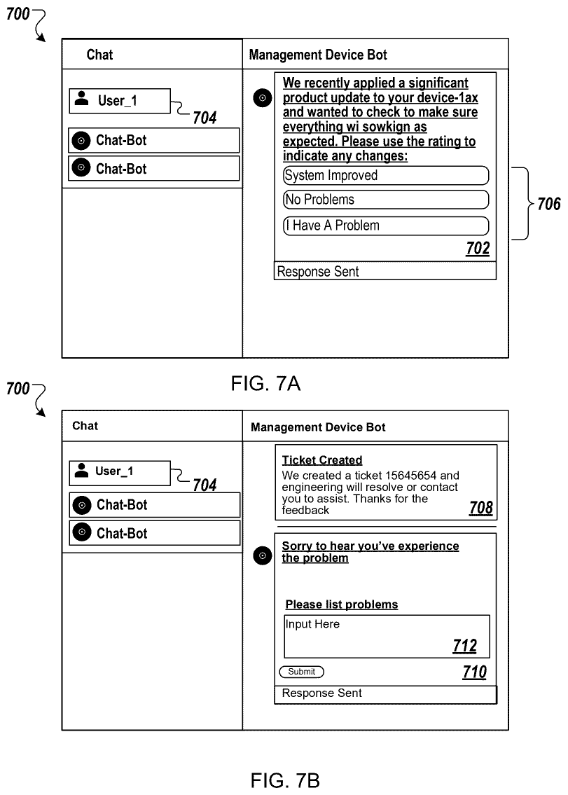

FIGS. 7A and 7B are an endpoint communication UX 700. The endpoint communication UX 700 may be displayed on one of the endpoints (e.g., 106 of FIG. 1) during some embodiments of the process 200 of FIG. 2. In the communication UX 700, a chat-bot may communicate with a user 704 to gather data related to a product update that was distributed to an endpoint associated with the user 704.

Referring to FIG. 7A, a first portion 702 of a post-patch survey is communicated such that the user 704 may view and respond to the first portion 702. For instance, the first portion 702 provides the user 704 with options 706 from which feedback data may be derived. The options 706 of the example in FIG. 7A include “system improved”, “no problems”, and “I have a problem”. Responsive to selection of “system improved” and “no problems”, feedback data may be generated indicating that the product update distribution or rollout was successful. The corresponding feedback data may be communicated to a survey module (e.g., 143) and to a model (e.g., 150).

Referring to FIG. 7B, responsive to selection of the option 706 “I have a problem,” in FIG. 7A, a second portion 708 of the post-patch survey may be displayed. The second portion 708 may provide ticket information for an ITSM ticket created to track the technical issue. A third portion 710 of the post-patch survey may be displayed as shown in FIG. 7B. The third portion 710 includes a data-gathering field 712 that receives specifics regarding the problem experienced by the user 704. Feedback data representative of the data provided in the data-gathering field 712 may be provided to the survey module and the model.

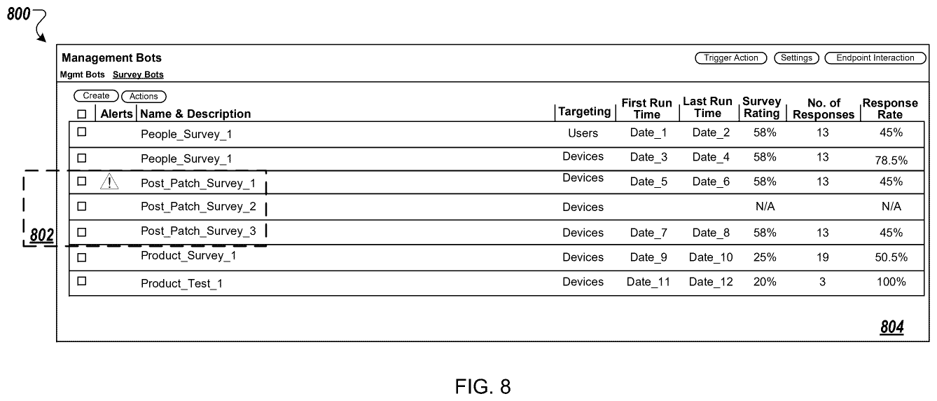

FIG. 8 is a bot-management UX 800 that may be implemented in a management device such as the management device 104 described in the present disclosure. The bot-management UX 800 may provide updated responses and feedback data regarding two or more post-patch surveys that are developed and/or deployed in a managed network. In the depicted embodiment, there are three post-patch surveys 802. Two of the post-patch surveys 802 are in process and one is queued up for communication to endpoints. The post-patch surveys 802 may be managed with one or more other surveys and data gathering mechanisms implemented in a managed network.

Data and information are displayed in the bot-management UX 800. For instance, dates that the post-patch survey have been communicated are displayed along with ratings, number of responses, and response rates. In addition, the bot-management UX 800 may enable an alert to display, which may indicate a mitigation action is implemented responsive to feedback data or a threshold number of negative responses have been received.

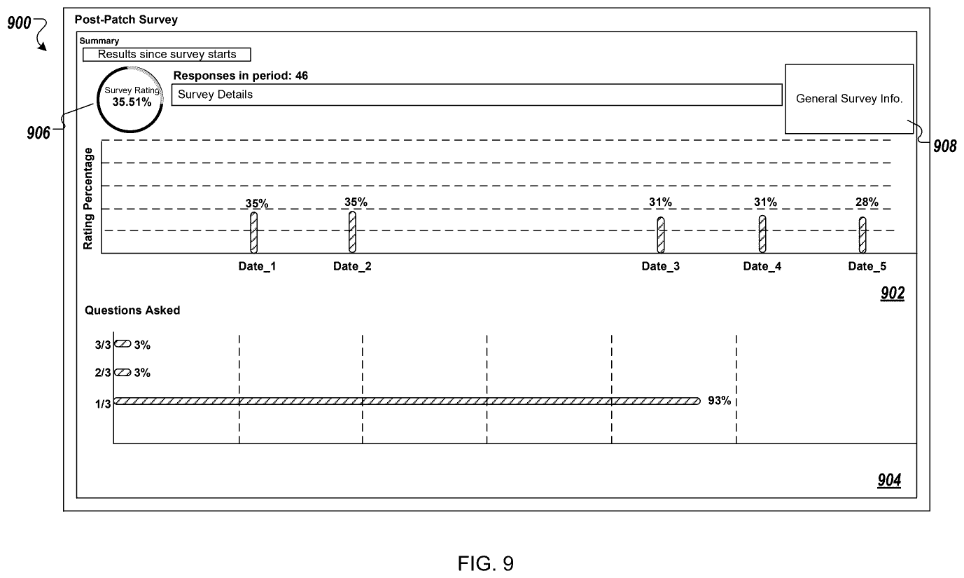

FIG. 9 is a post-patch survey UX 900 that may be implemented in a management device such as the management device 104 described in the present disclosure. The post-patch survey UX 900 may provide data and information related to a post-patch survey (e.g., 802 of FIG. 8). For instance, the post-patch survey UX 900 may include rating percentages on two or more dates in a first plot 902, general survey information in a data block 908, and a graphic 906 depicting a survey rating. The post-patch survey UX 900 may include a second portion 904 that provides a question-by-question breakdown of the survey.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the systems and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”), the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of automated product update analysis and management based on post-distribution feedback, the method comprising:
distributing a product update to a first subset of endpoints;
generating a data gathering mechanism directed to functionality of an aspect of the first subset of endpoints affected by the product update;
after implementation of the product update at the first subset of endpoints, communicating the data gathering mechanism to the first subset of endpoints, wherein the implementation includes a change or an update to a product installed at the first subset of endpoints;
receiving feedback data from a portion of the subset of endpoints, wherein the feedback data is responsive to the data gathering mechanism and addresses the functionality of the aspect;
determining, based on the feedback data, whether the implementation of the product update resulted in an update rollout failure at the first subset of endpoints that is caused by the product update;
in response to an indication of the update rollout failure at the first subset of endpoints:
mitigating a cause of the update rollout failure prior to distributing the product update to a second subset of endpoints; and
distributing the product update to the second subset of endpoints; and
in response to a determination that the distribution did not include the update rollout failure, distributing the product update to the second subset of endpoints.

2. The method of claim 1, wherein the determining whether the implementation resulted in the update rollout failure includes:
inputting the feedback data to a product update validation model configured to identify the update rollout failure at the first subset of endpoints caused by the product update; and
receiving an output from the product update validation model that includes the indication of the update rollout failure.

3. The method of claim 2, wherein:
the output further includes an indication that a threshold number of the first subset of endpoints are functional following distribution of the product update; and
responsive the threshold number being met, identifying distribution of the product update as successful and distributing the product update to the second subset of endpoints.

4. The method of claim 3, wherein:
the output further includes a mitigation action that modifies a parameter of one or both of the first subset of endpoints and the second subset of endpoints; and
the mitigating the cause includes modification of the parameter according to the mitigation action.

5. The method of claim 1, wherein:
the distributing the product update is performed according to a distribution procedure;
the distribution procedure includes a ring-based deployment operation; and
the communication of the data gathering mechanism occurs between distribution to a first ring of the ring-based deployment operation that includes the first subset of endpoints and a second ring of the ring-based deployment operation that includes the second subset of endpoints.

6. The method of claim 5, wherein the mitigating the cause of the update rollout failure occurs after the distribution to the first ring and prior to a distribution to the second ring.

7. The method of claim 1, further comprising:
receiving a customer symptom report of an additional managed network, wherein the customer symptom report includes an identification of a problematic aspect of a third subset of endpoints of the additional managed network that were affected by the product update; and
generating the data gathering mechanism based on the customer symptom report.

8. The method of claim 1, further comprising:
generating a social media-based symptom report, wherein the generating the social media-based symptom report includes:
scraping posts related to the product update from two or more different internet websites;
aggregating the posts from the internet websites;
extracting content from the aggregated posts;
based on the extracted content, summarizing the posts based on a graph-based ranking operation into a collection of terms or phrases that are representative of a topic of the posts;
analyzing the collection of terms or phrases to determine whether the topic is a problem with the product update, wherein the social media-based symptom report identifies the problem with the product update; and
generating the data gathering mechanism based on the social media-based symptom report.

9. The method of claim 8, wherein:
the extracting the content includes filtering non-informational content;
the scraping is based on a data identifier associated with the product update; and
the data identifier includes a knowledge base (KB) number or a patch bulletin number associated with the product update.

10. The method of claim 9, wherein the mitigating the cause of the update rollout failure comprises analyzing the extracted content to identify a solution to the problem.

11. A non-transitory computer-readable medium having encoded therein programming code executable by one or more processors to perform or control performance of operations of automated product update analysis and management based on post-distribution feedback, the operations comprising:
distributing a product update to a first subset of endpoints;
generating a data gathering mechanism directed to functionality of an aspect of the first subset of endpoints affected by the product update;
after implementation of the product update at the first subset of endpoints, communicating the data gathering mechanism to the first subset of endpoints, wherein the implementation includes a change or an update to a product installed at the first subset of endpoints;
receiving feedback data from a portion of the subset of endpoints, wherein the feedback data is responsive to the data gathering mechanism and addresses the functionality of the aspect;
determining, based on the feedback data, whether the implementation of the product update resulted in an update rollout failure at the first subset of endpoints that is caused by the product update;
in response to an indication of the update rollout failure at the first subset of endpoints:
mitigating a cause of the update rollout failure prior to distributing the product update to a second subset of endpoints; and
distributing the product update to the second subset of endpoints; and
in response to a determination that the distribution did not include the update rollout failure, distributing the product update to the second subset of endpoints.

12. The non-transitory computer-readable medium of claim 11, wherein the determining whether the implementation resulted in the update rollout failure includes:
inputting the feedback data to a product update validation model configured to identify the update rollout failure at the first subset of endpoints caused by the product update; and
receiving an output from the product update validation model that includes the indication of the update rollout failure.

13. The non-transitory computer-readable medium of claim 12, wherein:
the output further includes an indication that a threshold number of the first subset of endpoints are functional following distribution of the product update; and
responsive the threshold number being met, identifying distribution of the product update as successful and distributing the product update to the second subset of endpoints.

14. The non-transitory computer-readable medium of claim 13, wherein:
the output further includes a mitigation action that modifies a parameter of one or both of the first subset of endpoints and the second subset of endpoints; and
the mitigating the cause includes modification of the parameter according to the mitigation action.

15. The non-transitory computer-readable medium of claim 11, wherein:
the distributing the product update is performed according to a distribution procedure;
the distribution procedure includes a ring-based deployment operation; and
the communication of the data gathering mechanism occurs between distribution to a first ring of the ring-based deployment operation that includes the first subset of endpoints and a second ring of the ring-based deployment operation that includes the second subset of endpoints.

16. The non-transitory computer-readable medium of claim 15, wherein the mitigating the cause of the update rollout failure occurs after the distribution to the first ring and prior to a distribution to the second ring.

17. The non-transitory computer-readable medium of claim 11, wherein the operations further comprise:
receiving a customer symptom report of an additional managed network, wherein the customer symptom report includes an identification of a problematic aspect of a third subset of endpoints of the additional managed network that were affected by the product update; and
generating the data gathering mechanism based on the customer symptom report.

18. The non-transitory computer-readable medium of claim 11, wherein the operations further comprise:
generating a social media-based symptom report, wherein the generating the social media-based symptom report includes:
scraping posts related to the product update from two or more different internet websites;
aggregating the posts from the internet websites;
extracting content from the aggregated posts;
based on the extracted content, summarizing the posts based on a graph-based ranking operation into a collection of terms or phrases that are representative of a topic of the posts;
analyzing the collection of terms or phrases to determine whether the topic is a problem with the product update, wherein the social media-based symptom report identifies the problem with the product update; and
generating the data gathering mechanism based on the social media-based symptom report.

19. The non-transitory computer-readable medium of claim 18, wherein:
the extracting the content includes filtering non-informational content;
the scraping is based on a data identifier associated with the product update; and
the data identifier includes a knowledge base (KB) number or a patch bulletin number associated with the product update.

20. The non-transitory computer-readable medium of claim 9, wherein the mitigating the cause of the update rollout failure comprises analyzing the extracted content to identify a solution to the problem.
